(19) United States
(12) Patent Application Publication
(10) Pub. No.: US 2002/0043748 A1
(43) Pub. Date: Apr. 18, 2002

(54) HYDRAULICALLY DAMPING RUBBER SUPPORT

(75) Inventor: HEINRICH MEYER, KONIGSWINTER (DE)

Correspondence Address: THOMAS C PONTANI ESQ, COHEN PONTANI LIEBERMAN & PAVANE, 551 FIFTH AVENUE, SUITE 1210, NEW YORK, NY, 10176

(73) Assignee: COHEN PONTANI LIEBERMAN & PAVANE

(21) Appl. No.: 09/396,239

(22) Filed: Sep. 15, 1999

(30) Foreign Application Priority Data
Sep. 23, 1998 (DE) 198 43 558.4

(51) Int. Cl. F16F 9/00

(52) U.S. Cl. 267/140.11

(57) ABSTRACT

A hydraulic damping rubber support with at least one chamber filled with damping fluid, includes fixing elements for fixing the rubber support to a vehicle, and at least one flexible diaphragm which interacts with at least one perforated plate and is used to decouple vibrations. The diaphragm further includes an uneven portion disposed over at least part of its surface.

### BACKGROUND OF THE INVENTION

1. Field of the Invention

The invention relates to hydraulic damping devices, and more particularly to a hydraulically damping rubber support having at least one chamber filled with damping fluid.

2. Description of the Related Art

Hydraulically damping rubber supports in which the chambers filled with damping fluid are separated from one another by a flexible diaphragm are already known. A decoupling system of this kind has a rubber diaphragm which can oscillate between two plates provided with apertures. Within the free play between the two plates, these rubber diaphragms have a spring rate of 0 and are capable of decoupling small engine excitations (high-frequency vibrations) in an optimum manner. Moreover, the decoupling systems arc economical. The disadvantage, however, is that the difference in the characteristic for the decoupling as between free play and contact of the rubber diaphragm is very large. The rubber diaphragm strikes the plates and, in doing so, produces chattering noises, and this mechanical impact reaches an intensity dependent on the pressure rise in the interior of the support.

### SUMMARY OF THE INVENTION

It is an object of the invention to provide a rubber support in which a particularly economical and functionally reliable diaphragm decouples vibrations in an optimum manner and avoids the aforementioned chattering noises.

To achieve this and other objects, the present invention utilizes a diaphragm being uneven over at least part of its surface. An advantage of this embodiment is that the flexible diaphragm decouples in an optimum manner since the spring rate within the free play of the flexible diaphragm between the two plates is 0. This configuration presents high-frequency vibrations of an engine from being transmitted to the body of the vehicle. By virtue of the unevenness of the surface of the flexible diaphragm, it does not initially come to rest over an extended area against the plates but, after an initial line contact or point contact, still has a volume flexibility which avoids impact noises (chatter).

Another advantage is that the characteristic of the flexible diaphragm can be individually adjusted within a wide range of limits by means of the clearance, unevenness, hardness and thickness.

According to a further embodiment, the unevenness is in the form of at least one projection, or the unevenness is formed by a multiplicity of mutually spaced projections. It is advantageous here that point or line contact with the plates can be achieved as required, depending on the embodiment of the projections.

In a particularly advantageous embodiment, the unevenness is provided on both sides of the diaphragm. According to a further embodiment, the diaphragm is intrinsically wavy. It is advantageous here if the waviness is formed by concentric or radial waves.

According to yet a further embodiment, the diaphragm is provided with a bypass.

In an another advantageous embodiment, the diaphragm has, over at least part of its surface, uneven portions which have a point and/or line contact with the dividing wall in order to ensure a controlled further deformation of diaphragm with a defined stiffness and defined decoupling volume.

Provision is furthermore made for the diaphragm to be provided with a free play to decouple very small amplitudes while being held under a preload in the dividing wall.

In a functionally advantageous embodiment, the volume stiffness and/or decoupling volume of the diaphragm can be adjusted by means of the size of the uneven portions, the thickness of the diaphragm and/or the hardness of the diaphragm.

The various features of novelty which characterize the invention are pointed out with particularity in the claims annexed to and forming a part of the disclosure. For a better understanding of the invention its operating advantages, and specific objects attained by its use, reference should be had to the drawing and descriptive manner in which there are illustrated and described preferred embodiments of the invention.

### BRIEF DESCRIPTION OF THE DRAWINGS

Preferred embodiment examples of the invention are shown diagrammatically in the drawings, in which:

FIG. 1 is a sectional view of a hydraulically damping rubber support according to an embodiment of the invention;

FIG. 2 is a cross-section view of a flexible diaphragm taken along lines A-A of FIG. 3.

FIG. 3 is a top view of the centrally located portion of the hydraulically damping rubber support according to an embodiment of the invention;

FIG. 4 is an enlarged view of the detailed portion resented by “Z” in FIG. 2; and

FIG. 5 is a sectional view of the flexible diaphragm according to an embodiment of the invention.

### DETAILED DESCRIPTION OF THE PRESENTLY PREFERRED EMBODIMENTS

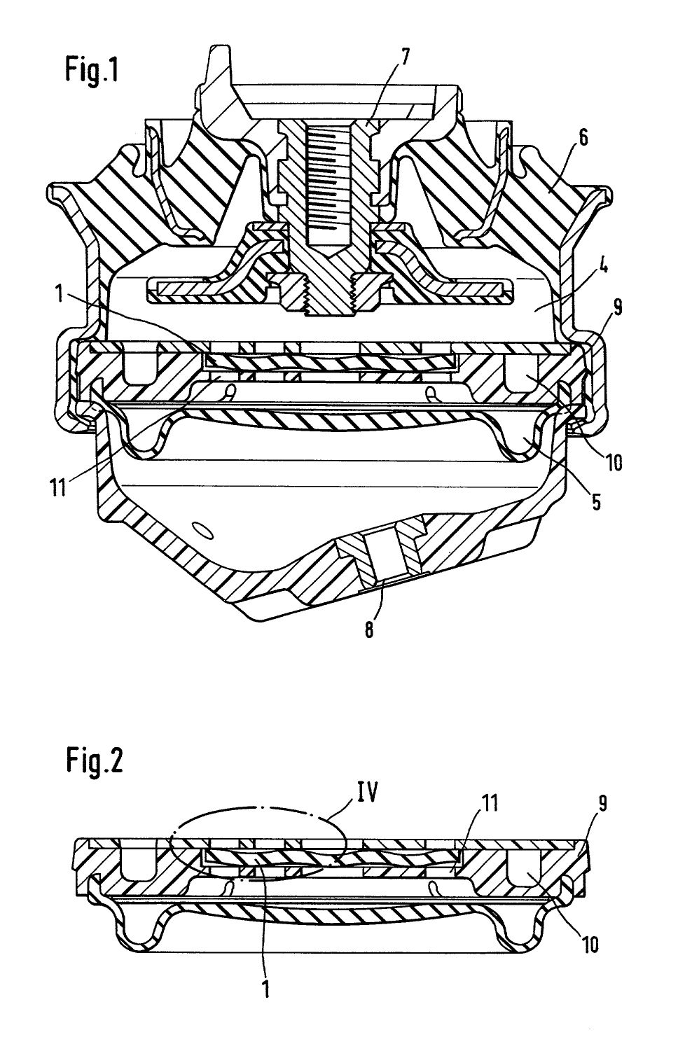

The hydraulically damping rubber support shown in FIG. 1 essentially comprises the two chambers 4 and 5 filled with damping fluid. It is possible, for example, for chamber 5 to be designed as a compensating space for holding the damping medium from chamber 4 in an unpressurized manner. The wall of chamber 4 is formed very largely by an elastomer body 6, with fixing elements 7 and 8 being provided for installation in the vehicle.

The two chambers 4 and 5 are separated by a dividing wall 9, having a damping passage 10 for enabling the damping medium to flow from one chamber to the other. The damping passage 10 can be designed as a simple hole (nozzle) or as a flow connection that extends in a ring around the circumference of the dividing wall 9.

The dividing wall 9 essentially comprises an upper and a lower rigid plate, which are provided with apertures 11 and between which the flexible diaphragm 1 is arranged such that it can move freely in an axial direction. The flexible diaphragm 1 can be inserted loosely between the two plates or clamped between the plates at its edge.

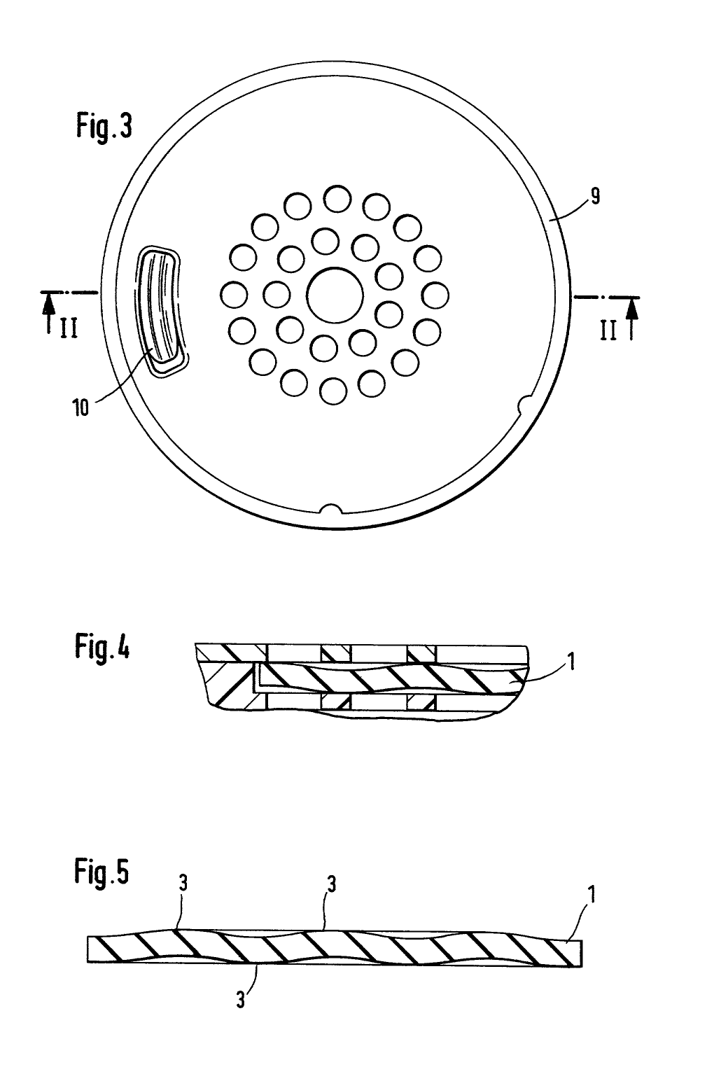

FIGS. 2-4 show various detailed views. The dividing wall a includes a flow connection as 9 damping passage 10 that runs in a ring around the axis of the support. The upper and lower plates of the dividing wall 9 are provided with apertures 11 through which the damping medium acts on the flexible diaphragm 1. From FIG. 2 it can be seen that, when the flexible diaphragm 1 is unclamped, it is chambered and by virtue of its clearance, comes to rest against one or the other plate of the dividing wall 9, depending on the pressure acting upon it from chambers 4 or 5.

The flexible diaphragm 1 can be provided with projections 2 or, as shown in FIG. 5, can have waves 3, these waves being arranged either concentrically or radially, with the result that the flexible diaphragm 1 does not come to rest directly against the plates of the dividing wall 9 over an extended area. Referring to FIG. 2, upon first being subjected to pressure by damping fluid through the apertures 11, flexible diaphragm 1 is moved axially and comes into point or line contact with the dividing wall 9, with the result that there is still a volume of flexibility remaining. The fact that the flexible diaphragm 1 comes to rest gradually against the dividing wall 9 prevents chattering caused by abrupt contact between the flexible diaphragm 1 and the dividing wall.

FIG. 5 shows an embodiment of flexible diaphragm 1 where waves 3 alternate in one direction, then the other. A flexible diaphragm 1 of this kind can come to rest gradually against both the upper and the lower plate of the dividing wall 9.

The invention is not limited by the embodiments described above which are presented as examples only but can be modified in various ways within the scope of protection defined by the appended patent claims.

We I claim:

1. A hydraulically damping rubber support comprising:
at least one chamber filled with damping fluid;
fixing elements for fixing the rubber support on a vehicle;
a dividing wall disposed within said at least one chamber;
at least one perforated plate disposed on a side of said dividing wall; and
at least one flexible diaphragm disposed in said dividing wall and under said at least one perforated plate for interacting with said at least on plate to de-couple vibrations in the vehicle said flexible diaphragm having an upper and lower surface and wherein at least part of one of said surfaces is uneven with respect to said plate.

2. The hydraulically damping rubber suppose in accordance with claim 1, wherein said uneven surface of said diaphragm comprise at least one projection.

3. The hydraulically damping rubber support in accordance with claim 1, wherein said uneven surface of said diaphragm comprises a plurality of mutually spaced projections.

4. The hydraulically damping rubber support in accordance with claim 1, wherein both said upper and lower surface comprise an uneven surface.

5. The hydraulically damping rubber support in accordance with claim 1, wherein said uneven surface of said diaphragm comprises a wavy surface.

6. The hydraulically damping rubber support in accordance with claim 5, wherein said wavy surface comprises concentric waves.

7. The hydraulically damping rubber support in accordance with claim 5, wherein said wavy surface comprises radial waves.

8. The hydraulically damping rubber support in accordance with claim 1, wherein said diaphragm further comprises a bypass.

9. The hydraulically damping rubber support in accordance with claim 1, wherein said uneven parts of said diaphragm comprise a point of contact with a dividing wall for controlling deformation of the diaphragm with a defined stiffness and defined de-coupling volume.

10. The hydraulically damping rubber support in accordance with claim 1, wherein said diaphragm is disposed so as to provide free play for de-coupling very small amplitudes of vibration.

11. The hydraulically damping rubber support in accordance with claim 1, wherein said diaphragm is pre-loaded in said dividing wall.

12. The hydraulically damping rubber support in accordance with claim 1, wherein said diaphragm further comprises a volume stiffness and de-coupling volume, wherein said volume stiffness and de-coupling volume can be adjusted by varying the size of said uneven surface.

13. The hydraulically damping rubber support in accordance with claim 1, wherein said diaphragm further comprises a volume stiffness, a de-coupling volume, and a thickness, wherein said volume stiffness and de-coupling volume can be adjusted by varying said thickness.

14. The hydraulically damping rubber support in accordance with claim 1, wherein said diaphragm further comprises a volume stiffness, a de-coupling volume, and a hardness, wherein said volume sniffiness and de-coupling volume can be adjusted by varying said hardness.
